(19) United States
(12) Patent Application Publication
(10) Pub. No.: US 2025/0181124 A1
(43) Pub. Date: Jun. 5, 2025

(54) INDUSTRIAL INTERNET OF THINGS (IIOT) ENERGY MANAGEMENT SYSTEM AND METHOD BASED ON MANAGEMENT CLOUD PLATFORM

(71) Applicant: CHENGDU QINCHUAN IOT TECHNOLOGY CO., LTD., Chengdu (CN)

(72) Inventor: Hanshu SHAO, Chengdu (CN)

(73) Assignee: CHENGDU QINCHUAN IOT TECHNOLOGY CO., LTD., Chengdu (CN)

(21) Appl. No.: 19/052,265

(22) Filed: Feb. 12, 2025

(30) Foreign Application Priority Data
Dec. 16, 2024 (CN) 202411847175.6

(51) Int. Cl. G06F 1/18; G05B 15/02

(52) U.S. Cl. CPC G06F 1/189; G05B 15/02

(57) ABSTRACT

Disclosed is an industrial Internet of Things (IIoT) energy management system and method based on a management cloud platform. The IIoT energy management system comprises the management cloud platform and an IIoT system. The IIoT system includes an IIoT management platform, an IIoT sensor network platform, and an IIoT perceptual control platform. The IIoT energy management method comprises: the IIoT management platform generating energy information, and sending the energy information to the management cloud platform; the management cloud platform receiving the energy information; determining an energy feature of one of target factories; determining a first energy distribution of one of the target factories; for a target factory of which the first energy distribution does not satisfy a first preset condition: obtaining a standard factory; generating a standard management parameter; and generating a regulation instruction and sending the regulation instruction to the IIoT management platform corresponding to the target factory.

### CROSS-REFERENCE TO RELATED APPLICATIONS

This application claims priority to Chinese Application No. 202411847175.6, filed on Dec. 16, 2024, the entire contents of which are incorporated herein by reference.

### TECHNICAL FIELD

The present disclosure relates to the field of Internet of Things (IoT) technology, and in particular to an industrial Internet of Things (IIoT) energy management system and method based on a management cloud platform.

### BACKGROUND

In the context of rapid development of modern industry, energy management has become a key part of enterprises to improve operational efficiency and reduce costs. The traditional way of energy management has problems such as data silos, lagging response, and inefficient management, which makes it difficult to meet the requirements of the modern industry for the refined management of energy. However, a cloud platform can deeply mine and process massive energy consumption data using big data analysis technology, which provides the enterprises with accurate energy consumption statistics, predictive analysis, energy efficiency assessment, etc.

Therefore, it is desirable to provide an industrial Internet of Things (IIoT) energy management system and method based on a management cloud platform for monitoring and management of various types of energy use in industrial production.

### SUMMARY

One aspect of the embodiments of the present disclosure provides an industrial Internet of Things (IIoT) energy management system based on a management cloud platform. The IIoT energy management system may comprise the management cloud platform and an IIoT system. The IIoT system may include an IIoT management platform, an IIoT sensor network platform, and an IIoT perceptual control platform. The IIoT management platform may be in communication with the management cloud platform. The IIoT management platform may be configured to: generate energy information based on energy monitoring data and an equipment operation parameter obtained from the IIoT perceptual control platform, and send the energy information to the management cloud platform, the energy information including at least one of equipment management information, production scheduling information, and energy scheduling information. The management cloud platform may be configured to: receive the energy information sent by the IIoT management platform; determine, based on the energy information, an energy feature of one of one or more target factories, the energy feature including at least one of an energy type, an energy usage amount and an energy utilization rate corresponding to the energy type; determine a first energy distribution of one of the one or more target factories based on the energy feature; for a target factory of which the first energy distribution does not satisfy a first preset condition: obtain a standard factory, the standard factory being of the same factory type as the target factory; generate a standard management parameter based on the energy information of the standard factory; and generate a first regulation instruction based on the standard management parameter and send the first regulation instruction to the IIoT management platform corresponding to the target factory, the first regulation instruction including at least one of an equipment regulation instruction, an energy regulation instruction, and a monitoring regulation instruction.

Another aspect of the embodiments of the present disclosure provides an industrial Internet of Things (IIoT) energy management method based on a management cloud platform, implemented by an industrial Internet of Things (IIoT) energy management system, comprising: an IIoT management platform generating energy information based on energy monitoring data and an equipment operation parameter obtained from an IIoT perceptual control platform, and sending the energy information to the management cloud platform, the energy information including at least one of equipment management information, production scheduling information, and energy scheduling information; the management cloud platform receiving the energy information sent by the IIoT management platform; the management cloud platform determining, based on the energy information, an energy feature of one of one or more target factories, the energy feature including at least one of an energy type, an energy usage amount and an energy utilization rate corresponding to the energy type; the management cloud platform determining a first energy distribution of one of the one or more target factories based on the energy feature; for a target factory of which the first energy distribution does not satisfy a first preset condition: the management cloud platform obtaining a standard factory, the standard factory being of the same factory type as the target factory; the management cloud platform generating a standard management parameter based on the energy information of the standard factory; and the management cloud platform generating a first regulation instruction based on the standard management parameter and sending the first regulation instruction to the IIoT management platform corresponding to the target factory, the first regulation instruction including at least one of an equipment regulation instruction, an energy regulation instruction, and a monitoring regulation instruction.

The embodiments of the present disclosure further provide an IIoT energy management device based on a management cloud platform. The IIoT energy management device may comprise at least one storage medium and at least one processor. The at least one storage medium may be configured to store computer instructions. The at least one processor may be configured to execute the computer instructions to implement the IIoT energy management method based on the management cloud platform.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering indicates the same structure, wherein

FIG. 1 is a schematic structural diagram illustrating an exemplary industrial Internet of Things (IIoT) energy management system based on a management cloud platform according to some embodiments of the present disclosure;

FIG. 2 is a flowchart illustrating an exemplary industrial Internet of Things (IIoT) energy management method based on a management cloud platform according to some embodiments of the present disclosure;

FIG. 3 is a flowchart illustrating an exemplary process of generating and sending a regulation instruction according to some embodiments of the present disclosure;

FIG. 4 is a schematic diagram illustrating an exemplary process of adjusting division of production periods according to some embodiments of the present disclosure; and

FIG. 5 is a schematic diagram illustrating an exemplary parameter adjustment model according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system” and/or “device” used herein are a way to distinguish between different components, elements, parts, sections, or assemblies at different levels. However, the terms may be replaced by other expressions if other words accomplish the same purpose.

As shown in the present disclosure and in the claims, unless the context clearly suggests an exception, the words “one,” “a,” “an,” “one kind,” and/or “the” do not refer specifically to the singular, but may also include the plural. Generally, the terms “including” and “comprising” suggest only the inclusion of clearly identified steps and elements, however, the steps and elements that do not constitute an exclusive list.

Flowcharts are used in the present disclosure to illustrate the operations performed by a system according to embodiments of the present disclosure, and the related descriptions are provided to aid in a better understanding of the magnetic resonance imaging method and/or system. It should be appreciated that the preceding or following operations are not necessarily performed in an exact sequence. Instead, steps can be processed in reverse order or simultaneously. Also, it is possible to add other operations to these processes or to remove a step or steps from these processes.

Some embodiments of the present disclosure provide an industrial Internet of Things (IIoT) energy management system and method based on a management cloud platform, which can be applied to a plurality of industrial production scenarios, such as electric power, chemical industry, and machinery manufacturing. For example, in an electric power production factory, the IIoT energy management system realizes refined management of energy by performing real-time monitoring of energy consumption such as electric power and gas, and communicating with the management cloud platform. As another example, in a machinery manufacturing factory, the IIoT energy management system can monitor energy consumption of mechanical energy, electric energy, etc., and provide customized energy management solutions based on the big data analysis capacity of the management cloud platform, thereby ensuring the stable operation of equipment while achieving energy saving and emission reduction.

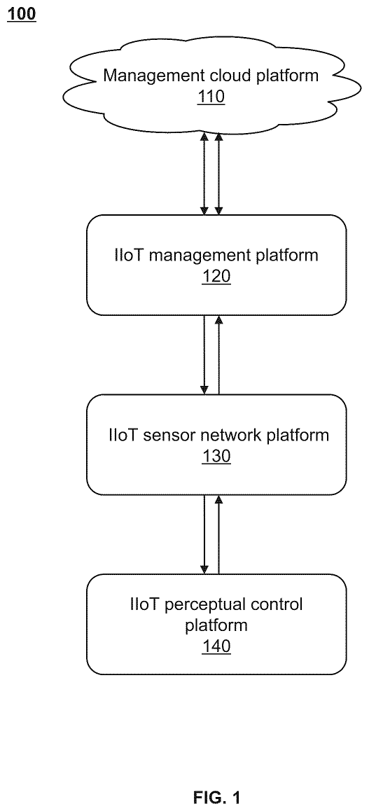

FIG. 1 is a schematic structural diagram illustrating an exemplary industrial Internet of Things (IIoT) energy management system based on a management cloud platform according to some embodiments of the present disclosure.

As shown in FIG. 1, an IIoT energy management system 100 based on the management cloud platform may include a management cloud platform 110, an IIoT management platform 120, an IIoT sensor network platform 130, and an IIoT perceptual control platform 140.

The management cloud platform 110 is a virtual management platform for providing computing, networking, and storage capacities. In some embodiments, the management cloud platform 110 facilitates remote services by reasonably and efficiently utilizing server resources.

In some embodiments, the management cloud platform 110 may be configured as a cloud server. Cloud refers to a server facility that can be remotely accessed and/or processed via a network. For example, the cloud includes a private cloud, a public cloud, a hybrid cloud, an industry cloud, etc. In some embodiments, the cloud may include a cloud processor. The cloud processor is a processor based on a cloud computing platform. For example, the cloud processor includes a central processing unit (CPU), an application-specific integrated circuit (ASIC), a microprocessor (MCU), or the like, or any combination thereof.

The IIoT management platform 120 is a platform configured within individual factories for performing IoT management.

In some embodiments, the IIoT management platform 120 may be configured as a single server or a server group. The server group may be centralized or distributed. In some embodiments, the server is local or remote.

In some embodiments, the IIoT management platform 120 may be configured to include a processor, such as a central processor, a microcontroller, an embedded processor (EP), a graphics processor (GPU), or the like, or any combination thereof.

In some embodiments, the IIoT management platform 120 may be in communication with the management cloud platform 110 to perform data interaction with the management cloud platform 110 via the network.

The IIoT sensor network platform 130 is a platform for controlling information sensing communication. For example, the IIoT sensor network platform 130 may be configured as a communication base station, a router, a wireless device, etc.

The IIoT perceptual control platform 140 is a functional platform for obtaining perceptual information and controlling instruction execution. In some embodiments, the IIoT perceptual control platform 140 may be provided in a factory production line, a factory storage and logistics center, or a factory equipment monitoring room. In some embodiments, the IIoT perceptual control platform 140 includes a sensing device for monitoring energy usage. For example, the sensing device includes a current sensor, a voltage sensor, a gas metering device, etc.

In some embodiments, the IIoT sensor network platform 130 may perform data interaction with the IIoT management platform 120 and the IIoT perceptual control platform 140.

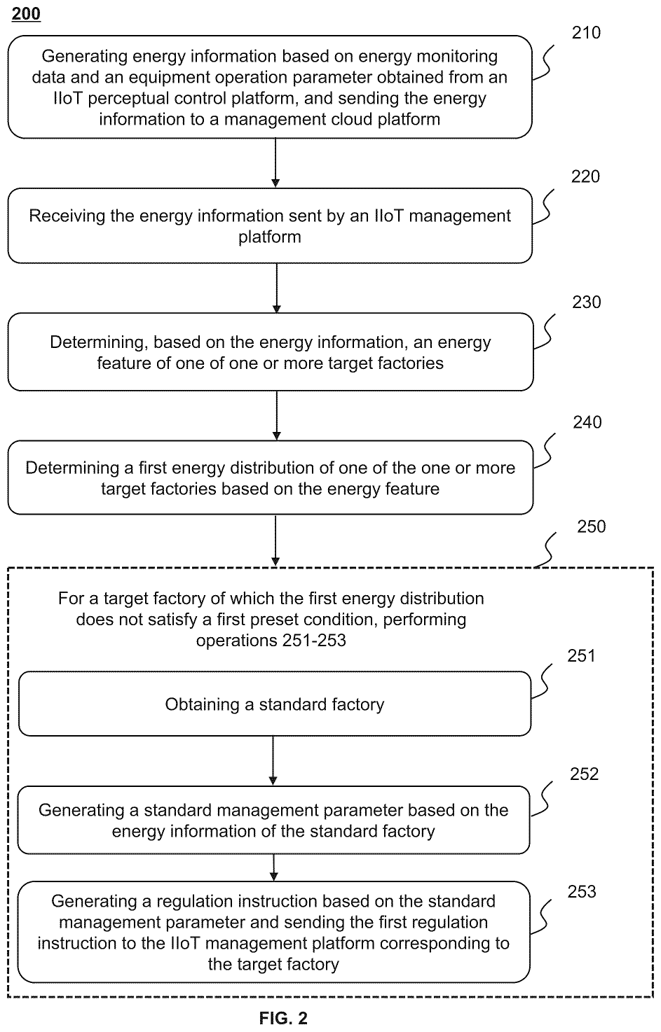

In some embodiments, the IIoT management platform 120 may obtain energy monitoring data and an equipment operation parameter from the IIoT perceptual control platform 140 through the IIoT sensor network platform 130, and generate, based on the obtained energy monitoring data and the equipment operation parameter, energy information and send the energy information to the management cloud platform 110. More descriptions may be found in FIG. 2 and the related descriptions thereof.

In some embodiments, the management cloud platform 110 may receive the energy information sent by the IIoT management platform 120; determine, based on the energy information, an energy feature of one of one or more target factories; determine, based on the energy feature, a first energy distribution of one of the one or more target factories; for a target factory of which the first energy distribution does not satisfy a first preset condition: obtain a standard factory; generate a standard management parameter based on the energy information of the standard factory; generate a regulation instruction based on the standard management parameter and send the regulation instruction to the IIoT management platform 120 corresponding to the target factory. More descriptions may be found in FIG. 2 and the related descriptions thereof.

It should be noted that the above description of the IIoT energy management system 100 based on a management cloud platform is provided only for descriptive convenience, and does not limit the present disclosure to the scope of the cited embodiments. For a person skilled in the art, with an understanding of the principle of the system, it is possible to arbitrarily combine various platforms or constitute subsystems to be connected to other platforms without departing from the principle.

FIG. 2 is a flowchart illustrating an exemplary industrial Internet of Things (IIoT) energy management method based on a management cloud platform according to some embodiments of the present disclosure.

In some embodiments, the IIoT management platform may generate energy information based on energy monitoring data and an equipment operation parameter obtained from an IIoT perceptual control platform, and send the energy information to the management cloud platform.

In some embodiments, the management cloud platform may receive the energy information sent by the IIoT management platform; determine, based on the energy information, an energy feature of one of one or more target factories; determine, based on the energy feature, a first energy distribution of one of the one or more target factories; for a target factory of which the first energy distribution does not satisfy a first preset condition: obtain a standard factory; generate, based on the energy information of the standard factory, a standard management parameter; generate, based on the standard management parameter, a regulation instruction and send the regulation instruction to the corresponding the IIoT management platform corresponding to the target factory.

As shown in FIG. 2, a process 200 may include the following operations. In some embodiments, the process 200 may be performed by both the IIoT energy management platform and the management cloud platform. Operation 210 may be performed by the IIoT energy management platform, and operations 220-250 (including operations 251-253) may be performed by the management cloud platform.

In 210, energy information may be generated based on energy monitoring data and an equipment operation parameter obtained from an IIoT perceptual control platform, and the energy information may be sent to a management cloud platform.

The energy monitoring data is monitoring data related to energy used by production equipment of a factory. In some embodiments, the energy monitoring data may include an energy type of energy used by the production equipment and a corresponding usage amount. The production equipment refers to equipment used by the factory to produce products, and the energy type may include electric energy, acoustic energy, mechanical energy, coal, gas, or the like.

In some embodiments, the IIoT energy management platform may obtain the energy monitoring data based on a sensing device of the IIoT perceptual control platform. For example, the IIoT energy management platform obtains a usage amount of electricity used by the production equipment through a current/voltage sensor, obtains a usage amount of gas used by the production equipment through a gas metering device, etc.

The equipment operation parameter is an operation parameter of relevant equipment of the factory.

In some embodiments, the equipment operation parameter may include a production equipment parameter and an energy equipment parameter. For example, the production equipment parameter may include a count of production equipment assigned to each production process and a corresponding working parameter (e.g., a working power, a working duration, etc.), and the energy equipment parameter may include an energy supply power of energy equipment (e.g., a motor, a boiler, etc.) corresponding to each energy type. The energy supply power of the energy equipment may be represented by an energy amount provided by the energy equipment per unit of time.

The energy information is information that reflects energy management within a factory.

In some embodiments, the energy information may include equipment management information, production scheduling information, and energy scheduling information.

The equipment management information refers to relevant parameters of each set of equipment. For example, the equipment management information may include a working power of the equipment and a corresponding working duration.

The production scheduling information reflects information related to production equipment assigned to different periods during the production process. For example, the production scheduling information may include a count of production equipment.

The energy scheduling information is scheduling information related to energy of each energy type. For example, the energy scheduling information may include a count of equipment, an energy supply power, and an energy supply duration of the energy equipment of each energy type, and energy types of energy used by the production equipment in different periods, and corresponding usage amounts.

In some embodiments, the IIoT management platform may generate the energy information based on the energy monitoring data and the equipment operation parameter in various ways and send the energy information to the management cloud platform. For example, the IIoT management platform may generate the equipment management information, the production scheduling information, and the energy scheduling information of the energy information by classifying and integrating based on the energy monitoring data and the equipment operation parameter, and send the energy information to the management cloud platform.

In 220, the energy information sent by an IIoT management platform may be received.

In some embodiments, the management cloud platform may receive the energy information sent by the IIoT management platform in various ways. For example, the management cloud platform may receive the energy information sent by the IIoT management platform via a network.

In 230, an energy feature of one of one or more target factories may be determined based on the energy information.

The one or more target factories are factories that require energy management. In some embodiments, a plurality of target factories may be provided.

The energy feature is data that characterizes an energy usage feature of the factory. In some embodiments, the energy feature may include at least one of an energy type, an energy usage amount and an energy utilization rate corresponding to the energy type. The energy utilization rate is an index that reflects the production efficiency of energy.

In some embodiments, the management cloud platform may determine the energy feature of one of the one or more target factories based on the energy information in various ways. For example, the management cloud platform may directly obtain the energy type and the energy usage amount corresponding to the energy type based on the energy scheduling information of the energy information.

The energy utilization rate may be expressed by a count of products produced per unit of energy. For example, the energy utilization rate may be determined by a ratio of a count of products produced by the production equipment to an energy usage amount used by the production equipment during a preset time period. The preset time period may be set manually, such as the last hour, day, or week from the current time.

In 240, a first energy distribution of one of the one or more target factories may be determined based on the energy feature.

The first energy distribution is data that reflects a distribution of an energy composition of each target factory. In some embodiments, the first energy distribution may include a proportion of the energy composition of each target factory, which may be represented by a matrix.

In some embodiments, the management cloud platform may determine the first energy distribution of one of the one or more target factories based on the energy feature in various ways. For example, the management cloud platform may determine the first energy distribution based on the energy feature by calculating a proportion of energy usage amounts of different energy types of each target factory to a total energy consumption of the corresponding target factory. For example, each element in a first energy distribution P may be calculated by the following equation (1):

$${P}_{i , j} = \frac{{E}_{i , j}}{{E}_{i}} * 100 \% \qquad ( 1 )$$

where i=1,2, . . . , n, j=1,2, . . . , m denote a target factory i and an energy type j, respectively, n denotes a total count of target factories, m denotes a count of energy types, P_{i,j} denotes a proportion of the energy type j of the target factory i and is expressed by an element in an ith row and a jth column of the first energy distribution P, E_{i,j} denotes an energy usage amount of the energy type j corresponding to the target factory i, and Eᵢ denotes the total energy consumption of the target factory i. The elements in the ith row of the first energy distribution P may form an energy distribution vector Pᵢ of the target factory i, i.e., Pᵢ={P_{i,1}, P_{i,2}, . . . , P_{i,m}}.

In 250, for a target factory of which the first energy distribution does not satisfy a first preset condition, operations 251-253 may be performed.

The first preset condition is a condition used to determine whether the target factory needs to be regulated.

In some embodiments, the first preset condition may be that for a target factory, an energy distribution vector of the target factory may match with energy distribution vectors of other target factories, the target factory and other target factories of which a similarity is greater than a similarity threshold may be sorted in a descending order according to an average value of the energy utilization rates of the energy types, and a sorting position of the target factory being within a first preset ratio means satisfying the first preset condition. The similarity threshold and the first preset ratio may be preset by those skilled in the art based on experience.

In 251, a standard factory may be obtained.

The standard factory is a factory that serves as a reference for energy regulation. In some embodiments, the standard factory may be one or more factories that are set manually. In some embodiments, the standard factory may also be one or more factories that satisfy a preset criterion. For example, the preset criterion may include that an energy utilization rate of a factory is higher than a first preset value and an energy usage amount of the factory is lower than a second preset value. The first preset value and the second preset value may be manually preset.

In some embodiments, the standard factory may be the same factory type as one of the one or more target factories.

The factory type is a type after categorization based on an energy-related feature of the factory. In some embodiments, the management cloud platform may obtain a plurality of factory types after categorization based on production scales, types of products, energy types of energy used by the factory, etc., which may be found in the related descriptions below.

In 252, a standard management parameter may be generated based on the energy information of the standard factory.

The standard management parameter is a parameter related to the standards for energy regulation.

In some embodiments, the standard management parameter may include a standard equipment parameter, a standard production parameter, and a standard energy parameter. The standard equipment parameter may include a standard working parameter of each production equipment. The standard production parameter may include a standard production equipment count assigned to each production process. The standard energy parameter may include a count of standard equipment used by the energy equipment of each energy type, a standard energy supply power, and a standard energy supply duration.

In some embodiments, the management cloud platform may generate the standard management parameter based on the energy information of the standard factory in various ways. For example, the management cloud platform may determine the standard management parameter based on a weighted sum of the energy information of a plurality of standard factories.

For example, the management cloud platform may determine the standard equipment parameter by performing weighted summation based on factory weight coefficients of the plurality of standard factories based on the working power and the working duration of each equipment in the plurality of standard factories; determine the standard production parameter by performing weighted summation on the factory weight coefficients of the plurality of standard factories based on the count of the production equipment assigned to each production process in the plurality of standard factories; and determine the standard energy parameter by performing weighted summation on the factory weight coefficients of the plurality of standard factories based on the energy supply power of the energy equipment of each energy type in the plurality of standard factories. The factory weight coefficients may be manually preset.

In 253, a regulation instruction may be generated based on the standard management parameter and the regulation instruction may be sent to the IIoT management platform corresponding to the target factory.

The regulation instruction is an instruction related to energy regulation for the target factory.

In some embodiments, the regulation instruction may include at least one of an equipment regulation instruction, an energy regulation instruction, and a monitoring regulation instruction.

The equipment regulation instruction is a regulation instruction related to the production equipment. The energy regulation instruction is a regulation instruction related to energy supply and usage. The monitoring regulation instruction is a regulation instruction related to the monitoring of the target factory.

In some embodiments, the management cloud platform may generate the regulation instruction based on the standard management parameter in various ways and send the regulation instruction to the IIoT management platform corresponding to the target factory. For example, the management cloud platform may determine the equipment regulation instruction based on the standard equipment parameter and the standard production parameter, such as adjusting the target factory based on the standard production equipment count, the standard working power, and the standard working duration.

As another example, the management cloud platform may determine the energy regulation instruction based on the standard energy parameter, such as adjusting the target factory based on the count of standard equipment used by the energy equipment of each energy type, the standard energy supply power, and the standard energy supply duration.

As another example, the management cloud platform may determine the monitoring regulation instruction by determining a monitoring frequency of the sensing device of the factory based on a difference between one of the one or more target factories and the standard factory and a difference between the energy utilization rates of the energy types. For example, the management cloud platform may determine a monitoring frequency Fᵢ of the sensing device of a target factory i based on the following equation (2):

$${F}_{i} = f * ( 1 + \frac{{\sum }_{p = 1}^{r} ( {Q}_{p}^{′} - {Q}_{i} )}{{\sum }_{p = 1}^{r} {Q}_{p}^{′}} ) \qquad ( 2 )$$

where f denotes a preset monitoring frequency, which is an original monitoring frequency preset manually, Qₚ′ denotes an average value of the energy utilization rates of the energy types in a standard factory p, r denotes a count of standard factories, and Qᵢ denotes an average value of the energy utilization rates of the energy types in the target factory i.

In some embodiments, after receiving the regulation instruction, the IIoT management platform may send the regulation instruction to the IIoT perceptual control platform to adjust a parameter of the corresponding equipment.

In some embodiments of the present disclosure, the energy information is sent to the management cloud platform through the IIoT management platform, and the management cloud platform determines the target factory that requires energy regulation based on the energy information to accordingly regulate the energy usage of the factory based on the standard management parameter of the standard factory of the same type, such that the factory type is considered, the more targeted energy regulation is realized, and the energy regulation is more efficient and accurate.

In some embodiments, the management cloud platform may be further configured to determine a plurality of factory types based on production scales, types of products, and energy types of energy of a plurality of target factories and standard factories, so as to categorize the target factories and the standard factories.

The production scale is an index of an output scale of a factory. For example, the production scale of a factory may be represented by a weighted sum of a total count of products produced per unit of time by the factory and the count of production equipment, and a weight may be manually set. In some embodiments, grades of the production scales may be determined based on division of different stages of data, and the higher the grade, the larger the production scale. The division of different stages of the data may be manually preset.

The types of products refer to broad categories to which the products belong. For example, products that are shoes, clothes, or the like, may be categorized as clothing, products that are cell phones, tablet computers, or the like, may be categorized as mobile devices, and so on.

In some embodiments, the management cloud platform may determine the plurality of factory types based on the production scales, the types of products, and the energy types of energy of the target factories in various ways. For example, the management cloud platform may determine the factory types by querying a first preset table based on the grades of the production scales, the types of products produced, and the energy types of energy used of different target factories. The first preset table may include a correspondence between the data and the factory types, which may be determined based on historical data or prior experience.

As another example, the management cloud platform may cluster the plurality of target factories and standard factories based on the production scales, the types of products, and the energy types of energy of the plurality of target factories and standard factories, and determine different clusters as different factory types based on clustering results. For one of the plurality of target factories or standard factories, a factory type corresponding to a cluster to which the target factory or the standard factory belongs is the factory type of the target factory.

In some embodiments of the present disclosure, by categorizing the target factories based on the production scales, the type of products produced, and the energy types of energy of the target factories, the target factories of different factory types can be more effectively regulated in a targeted manner.

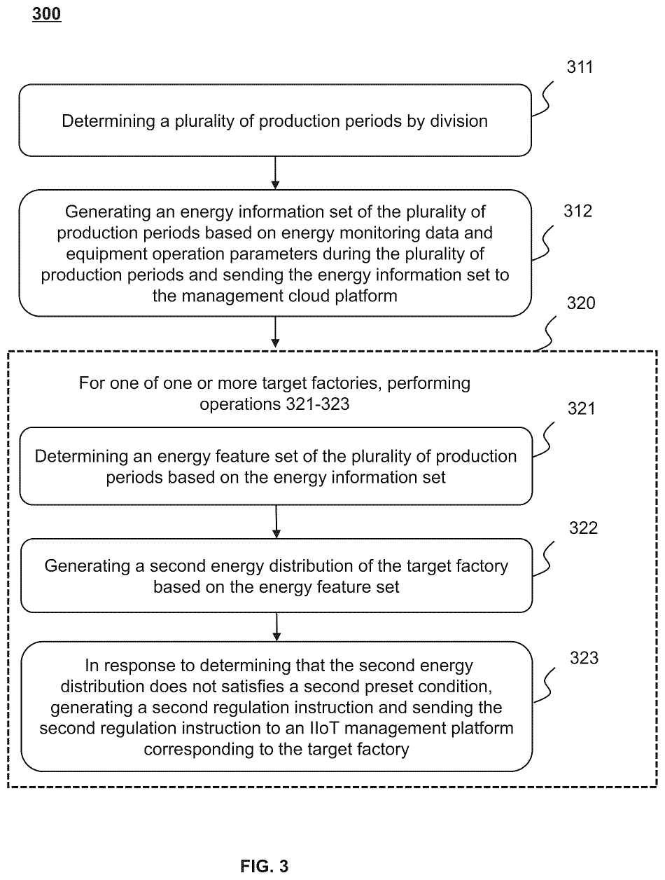

FIG. 3 is a flowchart illustrating an exemplary process of generating and sending a regulation instruction according to some embodiments of the present disclosure. As shown in FIG. 3, a process 300 may include the following operations. In some embodiments, the process 300 may be performed by both an IIoT management platform and a management cloud platform. Operations 311-312 may be performed by the IIoT management platform, and operation 320 (including operations 321-323) may be performed by the management cloud platform.

In some embodiments, the IIoT management platform may be further configured to determine a plurality of production periods by division; generate an energy information set of the plurality of production periods based on energy monitoring data and equipment operation parameters during the plurality of production periods and send the energy information set to the management cloud platform.

In some embodiments, the management cloud platform may be further configured to: for one of one or more target factories: determine an energy feature set of the plurality of production periods based on the energy information set; generate a second energy distribution of the target factory based on the energy feature set; and in response to determining that the second energy distribution does not satisfy a second preset condition, generate a regulation instruction and send the regulation instruction to the IIoT management platform corresponding to the target factory.

In 311, a plurality of production periods may be determined by division.

The production period is one of time periods during the production process of a factory.

In some embodiments, the IIoT management platform may determine the plurality of production periods by division in various ways. For example, the IIoT management platform may determine the plurality of production periods by division according to a production plan of the factory. For example, the IIoT management platform may determine different production periods by division based on production time corresponding to different production batches.

In 312, an energy information set of the plurality of production periods may be generated based on energy monitoring data and equipment operation parameters during the plurality of production periods, and the energy information set may be sent to the management cloud platform.

The energy information set is a set of energy information corresponding to the plurality of production periods.

In some embodiments, the IIoT management platform may generate the energy information set of the plurality of production periods based on the energy monitoring data and the equipment operation parameters during the plurality of production periods in various ways, and send the energy information set to the management cloud platform.

For example, the IIoT management platform may take the energy monitoring data at the end of each production period as the energy monitoring data corresponding to the production period, and take an average value of the equipment operation parameters during the production periods as the equipment operation parameter corresponding to the production period, and generate energy information corresponding to the production period based on the energy monitoring data and the equipment operation parameter corresponding to the production period, so as to generate the energy information set of the plurality of production periods, and send the energy information set to the management cloud platform via a network.

Each production period includes a plurality of time points. The energy monitoring data of the plurality of time points may form a monitoring data sequence, and the equipment operation parameters of the plurality of time points may form an operation parameter sequence. The process of generating the energy information based on the energy monitoring data and the equipment operation parameter may be found in FIG. 2 and the related descriptions thereof.

In 320, for one of the one or more target factories, operations 321-323 may be performed.

In 321, an energy feature set of the plurality of production periods may be determined based on the energy information set.

The energy feature set is a set of energy features corresponding to the plurality of production periods.

In some embodiments, the management cloud platform may determine the energy feature set of the plurality of production periods based on the energy information set in various ways. For example, the management cloud platform may determine, based on the energy information of each production period in the energy information set, an energy feature corresponding to the production period, and take a set of energy features corresponding to the plurality of production periods as the energy feature set. The process of determining the energy feature of the corresponding production period based on the energy information of the production period is similar to the process of determining the energy feature based on the energy information, which may be found in FIG. 2 and the related descriptions thereof.

In 322, a second energy distribution of the target factory may be generated based on the energy feature set.

The second energy distribution is a distribution that reflects energy usage of the factory in each production period. For example, the second energy distribution may include an average energy usage amount of the factory for each energy type during each production period. The average energy usage amount is an energy usage amount used by the factory for a particular energy type per unit of time.

In some embodiments, the management cloud platform may generate the second energy distribution of the target factory based on the energy feature set in various ways. For example, the management cloud platform may determine, based on an energy usage amount and an energy usage duration of the target factory for each energy type during different production periods, the average energy usage amount of each energy type during the corresponding production period, which in turn generates the second energy distribution of the target factory. For example, the management cloud platform may determine each element of a second energy distribution W according to the following equation (3):

$${W}_{k , j} = \frac{{E}_{k , j}}{{t}_{k}} \qquad ( 3 )$$

where k=1,2, . . . , q, j=1,2, . . . , m denote a production period k and an energy type j, respectively; q denotes a total count of the production periods, m denotes a count of the energy types, and W_{k,j} denotes the average energy usage amount of energy type j in the production period k, which is represented by an element in a kth row and a jth column of the second energy distribution W; E_{k,j} denotes the energy usage amount of the energy type j during the production period k, and tₖ denotes a duration of the production period k.

In 323, in response to determining that the second energy distribution does not satisfy a second preset condition, a second regulation instruction may be generated and sent to an IIoT management platform corresponding to the target factory.

The second preset condition is another condition used to determine whether the target factory requires regulation.

In some embodiments, the second preset condition may be that a mean of standard deviations of the usage amounts of the energy types does not exceed a preset standard deviation threshold. The standard deviation of the usage amount refers to a standard deviation of an average energy usage amount of a particular energy type during different production periods. For example, taking the second energy distribution W calculated above as an example, a standard deviation of the elements in the jth column of the second energy distribution W is the standard deviation of the usage amount of the energy type j.

In some embodiments, the management cloud platform may be further configured to: determine the second preset condition based on the energy information of the standard factory.

For example, the management cloud platform may calculate, for a plurality of standard factories, the standard deviation of the usage amount of each energy type, and calculate a mean of the standard deviations of the usage amounts of the energy types, and calculate a weighted sum of the means of the standard deviations of the plurality of standard factories based on factory weight coefficients to be used as a preset standard deviation threshold in the second preset condition, so as to determine the second preset condition. More descriptions regarding the factory weight coefficients may be found in the related descriptions of the operation 252.

In some embodiments of the present disclosure, by determining the second preset condition based on the energy information of the standard factory, the second preset condition that is more in line with an actual situation can be determined, thereby making the determination of whether to perform energy regulation more accurate.

In some embodiments, the management cloud platform may generate the regulation instruction in various ways and send the regulation instruction to the IIoT management platform corresponding to the target factory. For example, the management cloud platform may generate, based on the energy information of each production period of the standard factory, a standard management parameter corresponding to each production period, and generate, based on the standard management parameter of each production period, the regulation instruction corresponding to each production period, and send the regulation instruction to the IIoT management platform corresponding to the target factory.

The process of generating the standard management parameter corresponding to each production period based on the energy information of each production period of the standard factory may be similar to the process of generating the standard management parameter based on the energy information of the standard factory, which may be found in the related descriptions of the operation 252. The process of generating, based on the standard management parameter of each production period, the regulation instruction corresponding to each production period may be similar to the process of generating the regulation instruction based on the standard management parameters, which may be found in the related descriptions of the operation 253.

In some embodiments of the present disclosure, the plurality of production periods are determined, whether to perform energy regulation is determined based on the energy usage of the target factory in different production periods, and the corresponding instruction is determined, such that energy regulation for the target factory can be carried out more meticulously, thereby improving the accuracy of energy regulation.

In some embodiments, the one or more target factories may correspond to different factory types during different production periods.

In some embodiments, the management cloud platform may be further configured to determine the factory types corresponding to the one or more target factories during different production periods based on the production scales, the types of products produced, and the energy types of energy of the one or more target factories during different production periods.

In some embodiments, the management cloud platform may determine the factory types corresponding to the one or more target factories during different production periods based on the production scales, the types of products produced, and the energy types of energy of the one or more target factories during different production periods in various ways. For example, the management cloud platform may determine the factory types by querying a second preset table based on the grades of the production scales, the types of products produced, and the energy types of energy of the one or more target factories during different production periods. The second preset table may include a correspondence between the above data and the factory types. The second preset table may be determined based on historical data or prior experience. More descriptions regarding the grades of the production scales may be found in the related descriptions of FIG. 2.

As another example, the management cloud platform may cluster a plurality of target factories during different production periods based on the production scales, the types of products produced, and the energy types of energy of the plurality of target factories and standard factories during different production periods, and determine, based on clustering results, different clusters as different factory types. For a certain production period of one of the target factories, a factory type corresponding to a cluster to which the target factory belongs in the production period may be the factory type of the target factory in the production period.

In some embodiments of the present disclosure, the target factories correspond to different factory types during different production periods, such that the more accurate categorization can be performed based on different features of the production periods, thereby making the subsequent energy regulation more targeted.

It should be noted that the foregoing descriptions of the process 200 and the process 300 are for the purpose of exemplification and illustration only, and do not limit the scope of application of the present disclosure. For a person skilled in the art, various corrections and changes can be made to the process 200 and the process 300 under the guidance of the present disclosure. These corrections and changes remain within the scope of the present disclosure.

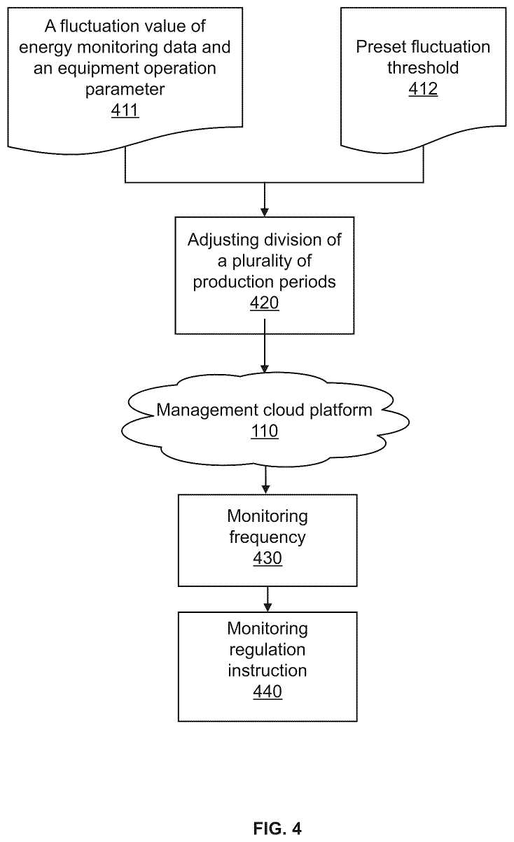

FIG. 4 is a schematic diagram illustrating an exemplary process of adjusting division of production periods according to some embodiments of the present disclosure.

In some embodiments, an IIoT management platform may be further configured to: in response to determining that a fluctuation value 411 of energy monitoring data and an equipment operation parameter exceeds a preset fluctuation threshold 412, adjust division 420 of a plurality of production periods.

The fluctuation value of the energy monitoring data and the equipment operation parameter is a value that reflects a value of a fluctuation of the energy monitoring data and the equipment operation parameter at a current time point relative to a previous time point. In some embodiments, the fluctuation value of the energy monitoring data and the equipment operation parameter may include a fluctuation value of the energy monitoring data and a fluctuation value of the equipment operation parameter.

In some embodiments, the fluctuation value of the energy monitoring data may be a change degree in an energy usage amount of each energy type in the energy monitoring data at the current time point compared with the previous time point in a monitoring data sequence of a production period, which may be expressed by the following formula (4):

$$Δ {E}_{l , k} = ( {\sum }_{j = 1}^{m} \frac{\vert {E}_{l , k , j} - {E}_{l - 1 , k , j} \vert}{{E}_{l - 1 , k , j}} ) \div m \qquad ( 4 )$$

where ΔE_{j,k} denotes a fluctuation value of the energy monitoring data at a current time point l during a production period k, E_{i,k,j} and E_{l-1,k,j} respectively denote an energy usage amount of an energy type j at the current time point l and a previous time point l−1 during the production period k, and m denotes a count of the energy types.

In some embodiments, the fluctuation value of the equipment operation parameter is a change degree of the working power of each production equipment and the energy supply power of each energy equipment in the equipment operation parameter at the current time point compared with the previous time point in the operation parameter sequence of one production period, which may be expressed by the following formula (5):

$$Δ {G}_{l , k} = \frac{\vert {\sum }_{r = 1}^{u} {g}_{r} * {G}_{l , k , r} - {\sum }_{r = 1}^{u} {g}_{r} * {G}_{l - 1 , k , r} \vert}{{\sum }_{r = 1}^{u} {g}_{k} * {G}_{l - 1 , k , r}} \qquad ( 5 )$$

where ΔG_{l,k} denotes a fluctuation value of the equipment operation parameter at the current time point l during the production period k, a total count of the production and the energy equipment is denoted as u, s denotes a count of the production equipment, and u−s denotes a count of the energy equipment. When r=1,2, . . . , s, gᵣ denotes a weight coefficient of the working power of production equipment r. G_{l,k,r} and G_{l-1,k,r} respectively denote the working power of the production equipment r at the current time point l and the previous time point l−1. When r=s+1, s+2, . . . , u, gᵣ denotes a weight coefficient of a power supply energy of the energy equipment r, and G_{l,k,r} and G_{l-1,l,r} respectively denote the power supply energy of the energy equipment r at the current time point l and the previous time point l−1. gᵣ may be manually preset.

The preset fluctuation threshold may be preset by those skilled in the art. In some embodiments, the preset fluctuation threshold may include a fluctuation threshold of the monitoring data sequence and a fluctuation threshold of the operation parameter sequence.

In some embodiments, in response to determining that the fluctuation value of the energy monitoring data and the equipment operation parameter exceeds the preset fluctuation threshold, the IIoT management platform may adjust the division of the plurality of production periods in various ways. For example, the IIoT management platform may use a current time point when the preset fluctuation threshold is exceeded as a division point to divide the corresponding production period into two subperiods, and determine energy information of a previous subperiod of the two subperiods in a similar process of determining the energy information during the production period, and send the energy information of the previous subperiod to the management cloud platform. The process of determining the energy information during the production period may be found in the related descriptions of FIG. 3.

In some embodiments of the present disclosure, by adjusting the division of the production periods when the fluctuation value of the energy monitoring data and the equipment operation parameter exceeds the preset fluctuation threshold, the production periods can be divided more meticulously based on the data, such that the subsequent analysis and energy regulation are more in line with the actual situation.

In some embodiments, the IIoT management platform may be further configured to: obtain a factory type to which the target factory belongs during the current production period, and determine the preset fluctuation threshold based on the monitoring data sequence and the operation parameter sequence of the standard factory.

In some embodiments, the IIoT management platform may determine the corresponding preset fluctuation threshold value based on the monitoring data sequence and the operation parameter sequence of the standard factory in various ways.

For example, the IIoT management platform may calculate standard deviations of energy usage amounts of energy types in energy detection data at the current time point in the monitoring data sequence of the standard factory, and multiply a mean of the standard deviations calculated for the plurality of standard factories by a first coefficient to obtain the fluctuation threshold of the monitoring data sequence; calculate a sum of standard deviations corresponding to the operation parameter sequence of the standard factory, the sum of standard deviations being a sum of the standard deviations of the working power of the production equipment in the equipment operation parameter at the current time point and the standard deviations of the energy supply power of the energy equipment, and multiply a mean of the sum of standard deviations calculated for the plurality of standard factories by a second coefficient to obtain the fluctuation threshold of the operation parameter sequence.

The first coefficient and the second coefficient may be preset numbers within a range of 1-3 based on the principle of triple standard deviation.

When the count of standard factories involved in the calculation is small, the probability of accidental factors is relatively large, and the standard deviation used to determine the preset fluctuation threshold may have a certain deviation. In this case, values of the first coefficient and the second coefficient may be increased to increase the preset fluctuation threshold that needs to be satisfied when adjusting the division of the plurality of production periods, so as to reduce adjustment. Accordingly, in some embodiments, the first coefficient and the second coefficient may be negatively correlated with the count of standard factories involved in the calculation.

In some embodiments of the present disclosure, by determining the preset fluctuation threshold based on the monitoring data sequence and the operation parameter sequence of the standard factory, the preset fluctuation threshold that conforms to the current data can be determined in real time, making the determination of whether the fluctuation value is normal more accurate, thereby allowing for a more reasonable division of the production periods.

In some embodiments, as shown in FIG. 4, the management cloud platform may be further configured to: determine a monitoring frequency 430 of a sensing device of one of the one or more target factories based on adjusted production periods; and generate a monitoring regulation instruction 440 based on the monitoring frequency 430 and send the monitoring regulation instruction 440 to the IIoT management platform corresponding to the target factory.

In some embodiments, the management cloud platform may determine the monitoring frequency of the sensing device of one of the one or more target factories based on the adjusted production periods in various ways. For example, for a subperiod in the adjusted production periods that does not perform monitoring, the management cloud platform may increase the monitoring frequency for the subperiod based on a duration of the subperiod, such that a count of data points within the subperiod is not less than a count of data points in the corresponding production period before adjustment, and generate a corresponding monitoring regulation instruction to be sent to the IIoT management platform corresponding to the target factory. The data points are time points at which the sensing device performs monitoring and acquires the energy monitoring data. It is understood that the shorter the duration of the subperiod that does not perform monitoring, the more the monitoring frequency of the subperiod needs to be increased.

For example, assuming that a production period A of a duration T₁ is divided into two subperiods a and b, and there should be n data points within the production period A according to an original monitoring frequency n/T₁. After division is adjusted, the IIoT management platform generates energy information of the subperiod a and sends the energy information of the subperiod a to the management cloud platform. In this case, the monitoring frequency of the sensing device is increased to n/T₂ based on a duration T₂ of the subperiod b, and the count of data points monitored in the subperiod b is increased to n.

In some embodiments of the present disclosure, the monitoring frequency is adjusted based on the adjusted production periods, so as to ensure that the subsequent production periods after analysis and adjustment have a sufficient amount of data, thereby making analysis results more accurate, and allowing for more reasonable energy regulation.

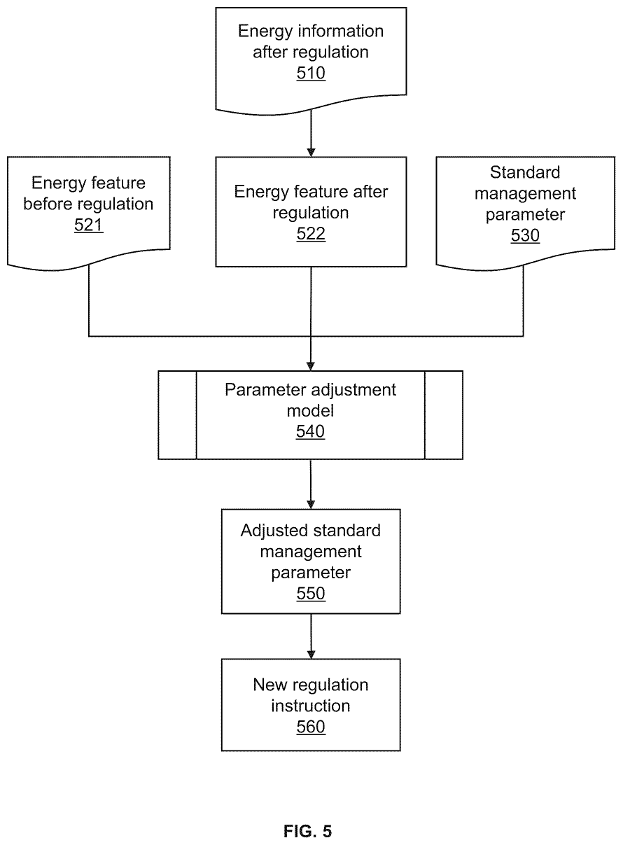

FIG. 5 is a schematic diagram illustrating an exemplary parameter adjustment model according to some embodiments of the present disclosure.

In some embodiments, as shown in FIG. 5, for a target factory of which a first energy distribution does not satisfy a first preset condition: the management cloud platform 110 may obtain energy information after regulation 510 of the target factory; determine an energy feature after regulation 522 of the target factory based on the energy information after regulation 510; adjust a standard management parameter 530 based on the energy feature after regulation 522 and an energy feature before regulation 521; and generate a new regulation instruction 560 based on an adjusted standard management parameter 550 and send the new regulation instruction 560 to the IIoT management platform corresponding to the target factory.

The energy information after regulation is energy information of the target factory adjusted according to the regulation instruction. In some embodiments, the energy information after regulation is energy information of a current production cycle after the target factory is adjusted according to a regulation instruction of a previous production cycle.

In some embodiments, the IIoT management platform may determine the energy information after regulation based on energy monitoring data and an equipment operation parameter of the current production cycle obtained from the IIoT perceptual control platform.

The energy feature after regulation is an energy feature of the target factory after implementing the regulation instruction.

In some embodiments, the management cloud platform may determine the energy feature after regulation of the target factory based on the energy information after regulation, which may be similar to the process of determining the energy feature, and may be found in the related descriptions of the operation 230.

In some embodiments, the management cloud platform may determine, based on the energy feature after regulation and the energy feature before regulation, a usage amount optimization coefficient, so as to adjust the standard management parameter. The energy feature before regulation refers to an energy feature of the target factory of the previous production cycle, which may be determined in the same process as the energy feature and may be found in the related descriptions of the operation 230.

The usage amount optimization coefficient is a coefficient used to indicate an optimization degree of an energy usage amount. For example, the usage amount optimization coefficient may include an optimization coefficient of an energy usage amount of each energy type.

In some embodiments, the management cloud platform may determine the usage amount optimization coefficient based on the energy feature after regulation and the energy feature before regulation in various ways. For example, the usage amount optimization coefficient may be correlated with an adjustment amount of the energy usage amount. For example, the usage amount optimization coefficient may be calculated according to the following equation (6):

$${Y}_{j} = \frac{{E}_{j} - {E}_{j}^{′}}{{E}_{j}} \qquad ( 6 )$$

where j=1,2, . . . , m denotes the energy types, m denotes a count of the energy types, Yⱼ denotes a usage amount optimization coefficient corresponding to an energy type j, Eⱼ denotes an energy usage amount of the energy type j before regulation, and Eⱼ′ denotes an energy usage amount of the energy type j after regulation. The energy usage amount before regulation may be obtained from the energy feature before regulation and the energy usage amount after regulation may be obtained from the energy feature after regulation. Taking regulation of non-clean energy, the energy usage amount after regulation should be less than the energy usage amount before regulation. Accordingly, Yⱼ should be a positive number, and the larger the value of Yⱼ, the better the regulation effect.

In some embodiments, the management cloud platform may adjust the standard management parameter based on the usage amount optimization coefficient in various ways. For example, the management cloud platform may obtain energy composition ratios of the plurality of standard factories, take an energy type with the smallest usage amount optimization coefficient of the target factory as a target energy type, increase a factory weight coefficient of the standard factory with the largest proportion of the energy usage amount of the target energy type by a preset adjustment amount, and correspondingly decrease a factory weight coefficient of the standard factory with the smallest proportion of the energy usage amount of the target energy type, and determine, based on a new factory weight coefficient, the adjusted standard management parameter.

For example, the current target factory has three energy types, a, b, and c, and the corresponding usage amount optimization coefficients Yₐ, Y_{b}, and Y_{c} are obtained. Assuming that the smallest usage amount optimization coefficient is Y_{b}, the management cloud platform increases the factory weight coefficient of a standard factory D with the largest proportion of the energy type b by a preset adjustment amount, and correspondingly decreases the factory weight coefficient of a standard factory E with the smallest proportion of the energy type b by the preset adjustment amount, and determines, based on a new weight coefficient, the adjusted standard management parameter. More descriptions regarding the factory weight coefficient of the standard factory and determining the standard management parameter based on the factory weight coefficient may be found in the related descriptions of the operation 252.

In some embodiments, the standard management parameters corresponding to different production periods may be different, as shown in FIG. 5. The management cloud platform may determine, based on the energy feature after regulation 522, the energy feature before regulation 521, and the standard management parameter 530 of the target factory, the adjusted standard management parameter 550 through a parameter adjustment model 540.

The parameter adjustment model is a model for determining the adjusted standard management parameter. In some embodiments of the present disclosure, the parameter adjustment model may be a machine learning model. For example, the parameter adjustment model may be one of a neural network (NN) model and a graph neural network (GNN) model, or a combination thereof.

In some embodiments, an input of the parameter adjustment model may include the energy feature after regulation, the energy feature before regulation, and the standard management parameter, and an output of the parameter adjustment model may include the adjusted standard management parameter. More descriptions regarding the energy feature after regulation, the energy feature before regulation, and the adjusted standard management parameter may be found in the related descriptions above.

In some embodiments, the parameter adjustment model may be trained in various ways based on a large number of first training samples with first labels. For example, parameter updating may be performed based on gradient descent. An exemplary training process includes: obtaining a plurality of first training samples with first labels; inputting the plurality of first training samples with the first labels into an initial parameter adjustment model, construct a loss function through the labels and results of the initial parameter adjustment model, and iteratively updating parameters of the initial parameter adjustment model based on the loss function by gradient descent or other modes. The training of the model is completed when a preset condition is satisfied, and a trained parameter adjustment model is obtained. The preset conditions may be that the loss function converges, a count of iterations reaches a threshold, etc.

In some embodiments, the first training samples may include a sample energy feature after regulation, a sample energy feature before regulation, and a sample standard management parameter of a plurality of standard factories of the factory types to which the factories belong during the production period. The first training samples may be determined based on historical data.

In some embodiments of the present disclosure, the first labels may be the adjusted standard management parameter corresponding to the first training samples. In some embodiments, the first labels may be an adjusted standard management parameter that has the optimal subsequent optimization effect in a plurality of adjustments of the first training samples. The optimization effect may be characterized by a reduction in the energy usage amount of each energy type. The more the reduction, the better the optimization effect.

In some embodiments of the present disclosure, the adjusted standard management parameter is determined through the parameter adjustment model, such that the adjusted standard management parameters corresponding to different production periods can be obtained, which helps to adjust the standard management parameter in real time according to the change in an actual production situation, and improves the production efficiency.

In some embodiments, after a preset count of training is performed, the management cloud platform may adjust a learning rate of the parameter adjustment model based on a decay factor.

The preset count of training is a preset count of model training. In some embodiments, the preset count of training may be determined based on a production feature of the production period. The production feature is a feature that reflects a production situation of the factory. For example, the production feature may include at least one of a duration of a production period, a count of equipment used, and an energy type of energy used. For example, the greater the weighted sum of the duration of the production period, the count of equipment used, and the count of energy types, the greater the preset count of training.

In some embodiments, the IIoT management platform may obtain the production feature from the IIoT perceptual control platform.

The decay factor is a parameter used to adjust the count of model training. For example, the decay factor may be within a range of 0.0-1.0. The decay factor may be determined based on experience.

The learning rate is a parameter used to control a weight update magnitude in a machine learning algorithm. In some embodiments, the learning rate is a configurable parameter used in neural network training. For example, the learning rate may be within a range of 0.0-1.0. A weight is a parameter used to calculate and estimate a relationship between an input sample and an output sample.

In order to make the model better learn a data feature of a training set, the preset count of training needs to be increased to delay the decay time of the learning rate in response to determining that the weighted sum of the production feature is large. In some embodiments, the learning rate of the model may be adjusted based on the production feature of the production period, so as to help the parameter adjustment model to better converge to the optimal solution, and avoid oscillation or failure to converge in the training process.

In some embodiments, the management cloud platform may generate a new regulation instruction based on the adjusted standard management parameter. For example, the management cloud platform may, after obtaining the adjusted standard management parameter, increase a supply priority of the energy type B, which in turn determines the new regulation instruction.

In some embodiments, different production periods correspond to different regulation instructions. For different production periods, the management cloud platform may generate the corresponding regulation instructions based on the standard management parameters corresponding to the production periods. The process of generating the corresponding regulation instructions based on the standard management parameters corresponding to the production periods may be similar to the process of generating the regulation instruction based on the standard management parameter, which may be found in the related descriptions of the operation 253.

In some embodiments of the present disclosure, the corresponding regulation instruction may be based on each production period, such that accurate regulation for each production period can be realized, which ensures that the production activities are carried out according to the preferred solution, thereby improving the production efficiency.

In some embodiments, the management cloud platform may send the new regulation instruction to the IIoT management platform corresponding to the target factory.

In some embodiments of the present disclosure, the energy utilization efficiency can be improved by dynamically adjusting the standard management parameter of the target factory. Meanwhile, the regulation instruction is generated and sent in real time, which ensures that the operation of the factory is in line with the preferred energy configuration and the energy cost is reduced, thereby enhancing the competitiveness of enterprises while promoting green production.

The basic concepts have been described above, and it is obvious to those skilled in the art that the above detailed disclosure is intended as an example only, and does not constitute a limitation of the present disclosure. There are various modifications and improvements that may be made to the present disclosure by those skilled in the art. Such modifications and improvements remain within the spirit and scope of the exemplary embodiments of the present disclosure.

“Some embodiments” means a feature, structure, or characteristic associated with at least one embodiment of the present disclosure. Some features, structures, or characteristics of one or more embodiments of the present disclosure may be suitably combined.

It should be noted that in order to simplify the presentation of the present disclosure, the foregoing descriptions of the embodiments of the present disclosure sometimes combine multiple features into a single embodiment, accompanying drawings, or description thereof.

In some embodiments, the numerical parameters used in the description and claims are approximate values, and the approximate values may be changed according to the required features of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

Finally, it should be understood that the embodiments described in the present disclosure are intended only to illustrate the principles of the embodiments of the present disclosure. As an example and not a limitation, alternative configurations of the embodiments of the present disclosure may be considered to be consistent with the teachings of the present disclosure.

What is claimed is:

1. An industrial Internet of Things (IIoT) energy management system based on a management cloud platform, comprising the management cloud platform and an IIoT system, wherein the IIoT system includes an IIoT management platform, an IIoT sensor network platform, and an IIoT perceptual control platform; the IIoT management platform is in communication with the management cloud platform;
the IIoT management platform is configured to:
generate energy information based on energy monitoring data and an equipment operation parameter obtained from the IIoT perceptual control platform, and send the energy information to the management cloud platform, the energy information including at least one of equipment management information, production scheduling information, and energy scheduling information;
the management cloud platform is configured to:
receive the energy information sent by the IIoT management platform;
determine, based on the energy information, an energy feature of one of one or more target factories, the energy feature including at least one of an energy type, an energy usage amount and an energy utilization rate corresponding to the energy type;
determine a first energy distribution of one of the one or more target factories based on the energy feature;
for a target factory of which the first energy distribution does not satisfy a first preset condition:
obtain a standard factory, the standard factory being of the same factory type as the target factory;
generate a standard management parameter based on the energy information of the standard factory; and
generate a regulation instruction based on the standard management parameter and send the regulation instruction to the IIoT management platform corresponding to the target factory, the regulation instruction including at least one of an equipment regulation instruction, an energy regulation instruction, and a monitoring regulation instruction.

2. The IIoT energy management system of claim 1, wherein the IIoT management platform is further configured to:
determine a plurality of production periods by division;
generate an energy information set of the plurality of production periods based on the energy monitoring data and the equipment operation parameter during the plurality of production periods and send the energy information set to the management cloud platform;
the management cloud platform is further configured to:
for one of the one or more target factories:
determine an energy feature set of the plurality of production periods based on the energy information set;
generate a second energy distribution of the target factory based on the energy feature set; and
in response to determining that the second energy distribution does not satisfy a second preset condition, generate a regulation instruction and send the regulation instruction to the IIoT management platform corresponding to the target factory.

3. The IIoT energy management system of claim 2, wherein the management cloud platform is further configured to: determine the second preset condition based on the energy information of the standard factory.

4. The IIoT energy management system of claim 3, wherein the one or more target factories correspond to different factory types during different production periods, and the management cloud platform is further configured to: determine the factory types corresponding to the one or more target factories in the different production periods based on production scales, types of products, and energy types of energy used of the one or more target factories during the different production periods.

5. The IIoT energy management system of claim 2, wherein the IIoT management platform is further configured to: in response to determining that a fluctuation value of the energy monitoring data and the equipment operation parameter exceeds a preset fluctuation threshold, adjust division of the plurality of production periods.

6. The IIoT energy management system of claim 5, wherein the management cloud platform is further configured to:
determine a monitoring frequency of a sensing device of one of the one or more target factories based on adjusted production periods; and
generate the monitoring regulation instruction based on the monitoring frequency and send the monitoring regulation instruction to the IIoT management platform corresponding to the target factory.

7. The IIoT energy management system of claim 1, wherein the management cloud platform is further configured to:
for the target factory of which the first energy distribution does not satisfy the first preset condition:
obtain energy information after regulation of the target factory;
determine, based on the energy information after regulation, an energy feature after regulation of the target factory;
adjust the standard management parameter based on the energy feature after regulation and the energy feature before regulation; and
generate a new regulation instruction based on an adjusted standard management parameter, and send the new regulation instruction to the IIoT management platform corresponding to the target factory.

8. The IIoT energy management system of claim 7, wherein different production periods correspond to different standard management parameters, and the management cloud platform is further configured to:
for the target factory of which the first energy distribution does not satisfy the first preset condition:
adjust the standard management parameters through a parameter adjustment model based on the energy feature after regulation, the energy feature before regulation, and the standard management parameter of the target factory, the parameter adjustment model being a machine learning model.

9. The IIoT energy management system of claim 8, wherein when the parameter adjustment model is trained, a learning rate of the parameter adjustment model is adjusted based on a decay factor after a preset count of training, the preset count of training being determined based on a production feature of each of the production periods, the production feature including at least one of a duration of each of the production periods, a count of equipment used, and energy types of energy used.

10. An industrial Internet of Things (IIoT) energy management method based on a management cloud platform, implemented by an industrial Internet of Things (IIoT) energy management system, comprising:
an IIoT management platform generating energy information based on energy monitoring data and an equipment operation parameter obtained from an IIoT perceptual control platform, and sending the energy information to the management cloud platform, the energy information including at least one of equipment management information, production scheduling information, and energy scheduling information;
the management cloud platform receiving the energy information sent by the IIoT management platform;
the management cloud platform determining, based on the energy information, an energy feature of one of one or more target factories, the energy feature including at least one of an energy type, an energy usage amount and an energy utilization rate corresponding to the energy type;
the management cloud platform determining a first energy distribution of one of the one or more target factories based on the energy feature;
for a target factory of which the first energy distribution does not satisfy a first preset condition:
the management cloud platform obtaining a standard factory, the standard factory being of the same factory type as the target factory;
the management cloud platform generating a standard management parameter based on the energy information of the standard factory; and
the management cloud platform generating a regulation instruction based on the standard management parameter and sending the regulation instruction to the IIoT management platform corresponding to the target factory, the regulation instruction including at least one of an equipment regulation instruction, an energy regulation instruction, and a monitoring regulation instruction.

11. The IIoT energy management method of claim 10, wherein the generating energy information based on energy monitoring data and an equipment operation parameter obtained from an IIoT perceptual control platform, and sending the energy information to the management cloud platform includes:
determining a plurality of production periods by division;
generating an energy information set of the plurality of production periods based on the energy monitoring data and the equipment operation parameter during the plurality of production periods and sending the energy information set to the management cloud platform;
the generating a regulation instruction based on the standard management parameter and sending the regulation instruction to the IIoT management platform corresponding to the target factory includes:
for one of the one or more target factories:
determining an energy feature set of the plurality of production periods based on the energy information set;
generating a second energy distribution of the target factory based on the energy feature set; and
in response to determining that the second energy distribution does not satisfy a second preset condition, generating a regulation instruction and sending the regulation instruction to the IIoT management platform corresponding to the target factory.

12. The IIoT energy management method of claim 11, wherein the in response to determining that the second energy distribution does not satisfy a second preset condition, generating a regulation instruction and sending the regulation instruction to the IIoT management platform corresponding to the target factory includes: determining the second preset condition based on the energy information of the standard factory.

13. The IIoT energy management method of claim 12, wherein the one or more target factories correspond to different factory types during different production periods, and the determining the second preset condition based on the energy information of the standard factory includes: determining the factory types corresponding to the one or more target factories in the different production periods based on production scales, types of products, and energy types of energy used of the one or more target factories during the different production periods.

14. The IIoT energy management method of claim 11, further comprising:
in response to determining that a fluctuation value of the energy monitoring data and the equipment operation parameter exceeds a preset fluctuation threshold, adjusting division of the plurality of production periods.

15. The IIoT energy management method of claim 14, further comprising:
determining a monitoring frequency of a sensing device of one of the one or more target factories based on adjusted production periods; and
generating the monitoring regulation instruction based on the monitoring frequency and sending the monitoring regulation instruction to the IIoT management platform corresponding to the target factory.

16. The IIoT energy management method of claim 10, further comprising:
for the target factory of which the first energy distribution does not satisfy the first preset condition:
obtaining energy information after regulation of the target factory;
determining, based on the energy information after regulation, an energy feature after regulation of the target factory;
adjusting the standard management parameter based on the energy feature after regulation and the energy feature before regulation; and
generating a new regulation instruction based on an adjusted standard management parameter, and sending the new regulation instruction to the IIoT management platform corresponding to the target factory.

17. The IIoT energy management method of claim 16, wherein different production periods correspond to different standard management parameters, and the adjusting the standard management parameter based on the energy feature after regulation and the energy feature before regulation includes:
for the target factory of which the first energy distribution does not satisfy the first preset condition:
adjusting the standard management parameters through a parameter adjustment model based on the energy feature after regulation, the energy feature before regulation, and the standard management parameter of the target factory, the parameter adjustment model being a machine learning model.

18. The IIoT energy management method of claim 17, wherein when the parameter adjustment model is trained, a learning rate of the parameter adjustment model is adjusted based on a decay factor after a preset count of training, the preset count of training being determined based on a production feature of each of the production periods, and the production feature including at least one of a duration of each of the production periods, a count of equipment used, and energy types of energy used.

19. An industrial Internet of Things (IIoT) energy management device based on a management cloud platform, comprising at least one storage medium and at least one processor, wherein:
the at least one storage medium is configured to store computer instructions; and
the at least one processor is configured to execute the computer instructions to implement the IIoT energy management method of claim 10.
